(19) United States
(12) Patent Application Publication
(10) Pub. No.: US 2023/0122557 A1
(43) Pub. Date: Apr. 20, 2023

(54) AIRCRAFT ELECTRIC PROPULSION SYSTEM CONTROL METHOD

(71) Applicant: ROLLS-ROYCE plc, London (GB)

(72) Inventor: Kacper Jakub GRZEDZINSKI, Bedford (GB)

(73) Assignee: ROLLS-ROYCE plc, London (GB)

(21) Appl. No.: 17/934,657

(22) Filed: Sep. 23, 2022

(30) Foreign Application Priority Data
Oct. 15, 2021 (GB) 2114747.5

(51) Int. Cl. B64D 27/24; B64C 11/30

(52) U.S. Cl. CPC B64D 27/24; B64C 11/305; B64D 2221/00

(57) ABSTRACT

A method of controlling an electric propulsion system of an aircraft. The propulsion system comprising an electric motor configured to drive a variable pitch propulsor. The method comprises determining a commanded thrust setting; determining one or more flight parameters; determining either a corresponding rotor governor speed and motor torque set-point, or a corresponding motor speed and rotor pitch angle set point, which provides the commanded thrust setting at the determined flight parameter having a maximum propulsion system efficiency; and controlling the rotor governor and electric motor in accordance with the determined respective set-points.

### CROSS-REFERENCE TO RELATED APPLICATIONS

This specification is based upon and claims the benefit of priority from United Kingdom patent application number GB 2114747.5 filed on Oct. 15, 2021, the entire contents of which is incorporated herein by reference.

### BACKGROUND

### Technical Field

The present disclosure concerns a method of controlling an aircraft electric propulsion system, a controller configured to control an aircraft propulsion system in accordance with the method, and a propulsion system incorporating the control system.

### Description of the Related Art

Electric propulsion systems have been proposed for aircraft, in which one or more electric motors drives one or more propulsors for provided thrust. According to a first aspect there is provided a method of controlling an electric propulsion system of an aircraft, the propulsion system comprising an electric motor configured to drive a variable pitch propulsor, the method comprising:

determining a commanded thrust setting;

determining one or more flight parameters;

determining either a corresponding rotor governor speed and motor torque set-point, or a corresponding motor speed and rotor pitch angle set point, which provides the commanded thrust setting at the determined flight parameter having a maximum propulsion system efficiency; and

controlling the rotor governor and electric motor in accordance with the determined respective set-points.

### SUMMARY

Advantageously, the system configured to control the propulsion system to an optimum propulsion system configuration which takes into account both electric motor efficiency and propeller efficiency characteristics, using data available from the aircraft.

The method may comprise consulting a lookup table which stores either a corresponding governor speed and motor torque set-point or a corresponding motor speed and rotor pitch angle set point for the determined one or more flight parameters.

The method may comprise inputting aircraft characteristics and flight parameters to an aircraft propulsion system model, and outputting one of the corresponding rotor governor speed and motor torque set-point, and the corresponding motor speed and rotor pitch angle set point.

The aircraft propulsion system model may comprise one or more of an aircraft drag model, a propeller efficiency model, a motor efficiency model, and a power source efficiency model.

The one or more aircraft flight parameters may include one or more of an aircraft true airspeed and aircraft equivalent airspeed.

The method may comprise determining a maximum propulsion system efficiency by calculating a minimum motor input power corresponding to the required thrust.

The method may comprise determining one or more safety parameters or operational limitations, and outputting rotor governor speed and motor torque set-point which meets these safety parameters or limitations. For example, the method may comprise determining one or more of a maximum rotor speed, motor torque, maximum rotor input current and maximum energy storage system output current and maintaining the corresponding rotor governor speed and motor torque set-point below their respective maxima.

The method may comprise determining one or more energy storage system efficiency parameters, and determining a corresponding rotor governor speed and motor torque set-point which provides the commanded thrust setting at the determined flight parameter with a maximum propulsion system efficiency. Advantageously, energy storage efficiency is taken into account when calculating a maximum propulsion system efficiency.

The method may comprise determining one or more power electronics efficiency parameters, and determining a corresponding rotor governor speed and motor torque set-point which provides the commanded thrust setting at the determined flight parameter with a maximum propulsion system efficiency. Accordingly, power electronics efficiency is taken into account when calculating a maximum propulsion system efficiency.

According to a second aspect of the disclosure there is provided a control system for an aircraft electric propulsion system, the aircraft propulsion system comprising:

a variable pitch propulsor;
an electric motor coupled to the variable pitch propulsor; and
a controller configured to control the variable pitch propulsor and electric motor in accordance with the method of the first aspect.

According to a third aspect there is provided an aircraft propulsion system comprising a control system in accordance with the second aspect.

The aircraft propulsion system may comprise one or more energy storage units. One or more energy storage unit may comprise one or more chemical batteries, one or more fuel cells, or one or more capacitors.

The aircraft propulsion system may comprise one or more internal combustion engines such as one or more gas turbine engines. One or more internal combustion engines may be mechanically coupled to one or more propulsors in a parallel configuration. Alternatively or in addition, one or more internal combustion engines may be mechanically coupled to one or more electric generators. The one or more electric generators may be coupled to one or both of the energy storage units, and one or more electric motor coupled to a propulsor.

According to a fourth aspect there is provided an aircraft comprising a propulsion system in accordance with the third aspect.

According to a fifth aspect there is provided a non-transitory computer storage medium comprising instructions for carrying out the method of the first aspect.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

An embodiment will now be described by way of example only, with reference to the Figures, in which:

FIG. 1 is a plan view of a first aircraft comprising an electric propulsion system;

FIG. 2 is a schematic diagram of an electric propulsion system for the aircraft of FIG. 1;

FIG. 3 is a graph showing an efficiency map for an inverter and motor combination of the electric propulsion system of FIG. 2 as a function of torque and motor rotational speeds;

FIG. 4 is a graph showing an efficiency map for a propeller of the electric propulsion system of FIG. 2 as a function of coefficient of power and advance ratio;

FIG. 5 is a graph illustrating modified coefficient of thrust UT as a function of coefficient of power and advance ratio;

FIG. 6 is a flow diagram illustrating a method of calculating an online model or look-up table correlating airspeed and desired thrust with a maximally efficient propulsion system configuration; and

FIG. 7 is a flow diagram illustrating a method of control of the electric propulsion system of FIG. 2 according to the look-up table or model calculating in accordance with the method of FIG. 6.

### DETAILED DESCRIPTION

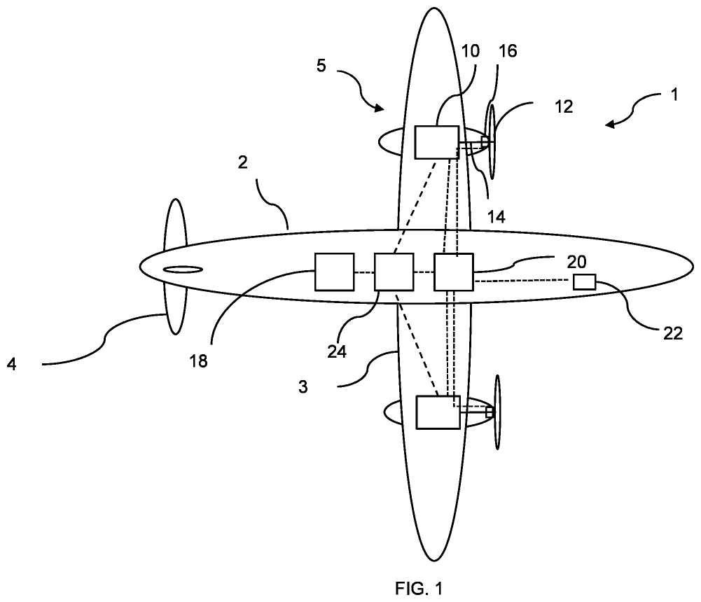

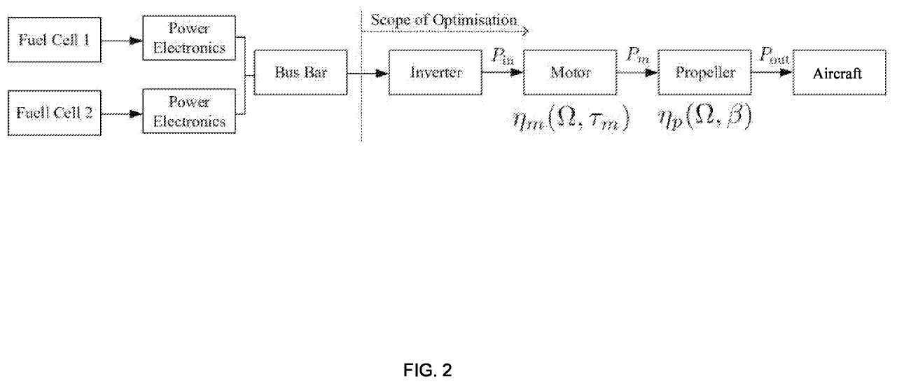

With reference to FIG. 1, an aircraft 1 is shown. The aircraft is of conventional configuration, having a fuselage 2, wings 3, tail 4 and an electric propulsion system 5. Indeed, in some embodiments, the aircraft 1 is an existing airframe which has been adapted for electric propulsion. The propulsion system is shown schematically in more detail in FIG. 2.

The propulsion system 5 comprises a propulsion unit on each wing comprising an electric motor 10 mechanically coupled to a propulsor in the form of a propeller 12 via a shaft 14 and propeller pitch change mechanism 16. As will be appreciated, other forms of propulsor such as ducted fans could also be used. The propeller 12 and pitch change mechanism 16 are of conventional construction. The propeller pitch change mechanism 16 is configured to alter the pitch of the blades of the propeller 12 (i.e. to change the angle of attack of the blades relative to the oncoming airstream) during flight. In some cases, a reduction gearbox (not shown) may be provided between the shaft 14 and propeller 12, which is configured to reduce the speed of the propeller 12 relative to the motor 10. In other cases, the motor 10 is directly coupled to the propeller 12 via the shaft 14.

The propulsion system 5 is powered by an energy storage system 18. In the present embodiment, the energy storage system is a hydrogen fuel cell, though other energy storage technologies such as chemical batteries or capacitors could be used instead of or in addition to one or more fuel cells. The energy storage system produces electrical power in the form of Direct Current (DC). In some instances, this DC current may be converted to an AC current by one or more power electronics systems 24 in the form of one or more inverters, provided between the energy storage system 18 and motors 10.

FIG. 2 illustrates the power conversion chain from the energy storage unit 18 to the propeller 12. Energy is provided from one or more energy storage units (fuel cell 1 and 2 in FIG. 2), which is provided via power electronics in the form of battery controllers to a main DC bus bar. Power from the main DC bus bar is converted to AC power at the required frequency, voltage and current by inverters to respective motors. The motors drive respective propellers, to provide propulsive thrust to the aircraft.

Referring again to FIG. 1, the propulsion system 5 is controlled by a controller 20. The controller 20 is in signal communication with the energy storage unit 18, motors 10 and propeller pitch change mechanism 16 and a flight control system 22, and is configured to control at least the motor 10 and pitch change mechanism 16 in response to control inputs from the flight control system 22.

The controller 20 is typically a digital electronic control system comprising a memory, processing unit and input/outputs, and is of conventional construction. The controller 20 comprises control software comprising a look-up table or look-up tables. The look-up table is configured to take inputs in the form of at least a thrust demand from the flight control system and one or more flight parameters, such as true or equivalent air speed from an air data system, and correlate these inputs to a corresponding target motor/propeller target parameter pair which provides an optimum (i.e. a computed highest possible) efficiency of the propeller 12/motor 10 combination. These parameter pairs comprise either a corresponding target motor speed Ωₘ and target pitch angle β for the pitch change mechanism 16 for the associated propeller 12, or a corresponding governor speed set-point Ωₚ and target motor torque τₘ for the motors 10, as shown in the below table:

| | Parameter pair 1 | Parameter pair 2 |
|---|---|---|
| Propeller | Pitch Angle β | Governor speed Ωₚ |
| Motor | Motor Speed Ωₘ | Motor Torque τₘ |

Each parameter pair represents two degrees of freedom that can be controlled to provide the necessary thrust. For steady state operation of the propulsion system, both options are equally valid and are broadly equivalent—the optimum efficiency can be achieved using either option for a given flight condition. There are however advantages and disadvantages of controlling the system in accordance with each of these methods.

An advantage of using parameter pair 2 (governor speed Ωₚ and motor torque τₘ), is that, when installing the system on an existing airframe, the existing propeller speed governor can be utilised without adapting the propeller, or propeller pitch control mechanism. This may make certification more straightforward. On the other hand, the parameter pair 1 provides for more direct control of propeller pitch. By removing the constant speed governor, this may also remove transient performance limitations caused by the hydro-mechanical dynamics from the constant speed governor (e.g. slower response due to inertia of counter-weights).

Once a target parameter pair is derived, either from the propulsion system model or the lookup table, the controller then controls the actual parameters, such that errors between the target values and a measured or estimated parameter pair are minimised. In one example, this is achieved using a closed loop conventional Proportional, Integral, Derivative (PID) controller. Alternative control methodologies such as open-loop model-based control may alternatively be used. Optionally, additional propulsion system component efficiencies may be considered by the controller when determining an optimum propulsion system configuration. For example, the efficiency of the inverter may be considered.

The optimum values for the target parameter pairs can be calculated online by the controller using a propulsion system model, or offline and stored in a lookup table. In either case, the optimum values are calculated by consideration of the airframe drag and component efficiencies of the propulsion system, and an optimum target parameter pair can then be calculated for a desired thrust level for a given airspeed.

Referring again to FIG. 2, each of the inverter 24, motor, 10 and propeller 12 have respective efficiencies, which will necessarily be less than 100% in each case. For example, the inverter will have an efficiency η_{I} defined by the AC electrical output power in watts divided by the DC electrical input power in watts. Efficiencies below 100% represent thermal losses. This efficiency is typically a function of AC output frequency f and load P. Similarly, the motor will have an efficiency ηₘ, defined by the useful mechanical output power in watts, divided by the electric input power in watts. This efficiency is typically a function of motor speed Ωₘ and torque τₘ for a given motor output power. Since the motor speed Ωₘ is tied to inverter output frequency f, these components do not have separate degrees of freedom, and so the two components can be combined to define a single motor/inverter efficiency metric when considering their efficiencies.

Similarly, the propeller 12 will have an efficiency ηₚ, defined by the useful mechanical output power (thrust) in watts, divided by the mechanical input power in watts. This efficiency is typically a function of rotational speed Ωₚ and pitch angle β for a given propeller output power. It will be appreciated that, in the case of a directly coupled motor 10 and propeller 12, the propeller rotational speed Ωₚ and motor rotational speed Ωₘ will be equal. Where a gearbox is provided, these speeds will be a fixed multiple of one another, wherein the propeller speed Ωₚ is typically lower than the motor speed Ωₘ. The gearbox (where present) also has an efficiency, which may be related to rotational speed. However, since the propeller 12 and gearbox rotate together, these can be treated as a single unit, with a single efficiency metric.

Consequently, each of the inverter 24, propeller 16 and motor 10 have an efficiency profile which varies according to various parameters. Each of these factors must be considered and weighted to find an optimum propulsion system configuration.

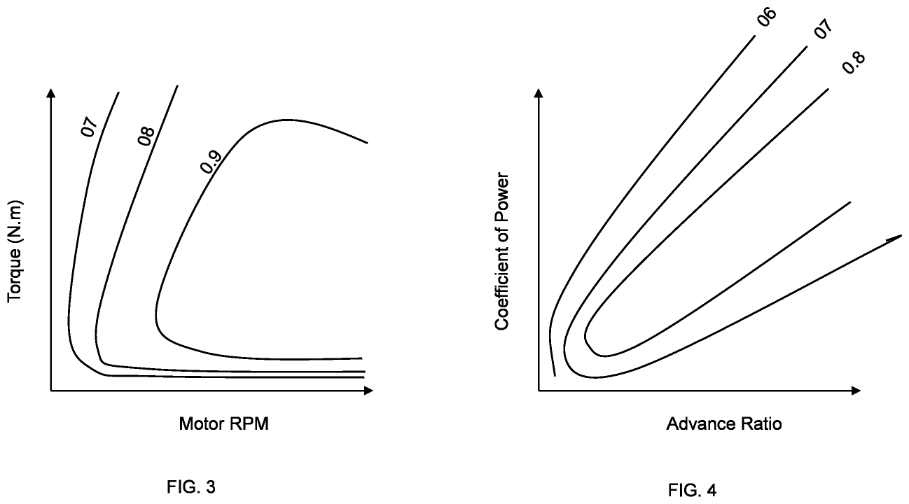

FIG. 3 shows an efficiency profile for a combined motor 10 and inverter 24 pair. The efficiency profile comprises a graph showing motor torque τₘ (which can be measured in newton metres) and motor speed Ωₘ (which can be measured in RPM) and corresponding efficiency isolines (marked as 0.9, 0.8 and 0.7). This data can be determined using computer modelling, or experimental testing. As can be seen, efficiency varies greatly from around 0.7 (i.e. 70% efficiency) at some speeds and torque settings, to 0.9 (i.e. 90%) at others. In principle, a given power can be generated by rotating the motor relatively slowly at a high torque, or relatively quickly at a low torque. However, the efficiency at which this power is produced varies considerably, with a complex relationship between motor speed and torque. In general however, a single torque and speed combination can be defined which provides the necessary power at the highest efficiency.

FIG. 4 shows an efficiency profile for a propeller 12 or propeller and gearbox combination. Again, the efficiency profile comprises a graph showing the coefficient of power C_{P} of the propeller 12 and advance ratio J, and corresponding efficiency isolines (marked as 0.8, 0.7 and 0.6).

The advance ratio J is a non-dimensional number given by the following well-known equation:

$$J = \frac{60 {V}_{TAS}}{Nd} \qquad Equation 1$$

Where V_{TAS} is the true airspeed, N is the rotational speed of the propeller in revolutions per minute, and d is the diameter of the propeller. An interesting result of this research is that the correct configuration for propulsion system overall maximum efficiency can be calculated from true airspeed, rather than indicated airspeed, or any other flight parameter. This is because the propeller efficiency depends on advance ratio, which is a function of the actual relative velocity of airflow over the propeller due to aircraft forward motion (true airspeed), rather than dynamic pressure (indicated airspeed). In some cases, true airspeed may be calculated from equivalent airspeed or any other airspeed which is available using the aircraft air data sensors.

Similarly, the propeller power coefficient C_{P} is given by the following well-known equation:

$${C}_{P} = \frac{{P}_{shaft}}{ρ {N}^{3} {d}^{5}} \qquad Equation 2$$

Where P_{shaft} is shaft input power, p is the fluid density, N is the rotational speed of the propeller in revolutions per second, and d is the diameter of the propulsor.

As can be seen, efficiency varies greatly from around 0.6 (i.e. 60% efficiency) at some advance ratios and coefficients of power, to 0.8 (i.e. 80%) at others. In principle, a given thrust can be generated by rotating the propeller relatively slowly at a high pitch, or relatively quickly at a low pitch. However, the efficiency at which this thrust is produced varies considerably, with a complex relationship between speed and pitch, which is governed by the relationship between the coefficient of power and the advance ratio. In general however, a single (or in some cases two) combination can be found, which provides the necessary thrust at the highest efficiency. Again, this data can be determined using computer modelling such as CFD, or via wind tunnel testing. Note that the data shown in FIG. 4 is a subset of contours within the full tabulated data for the propeller 12.

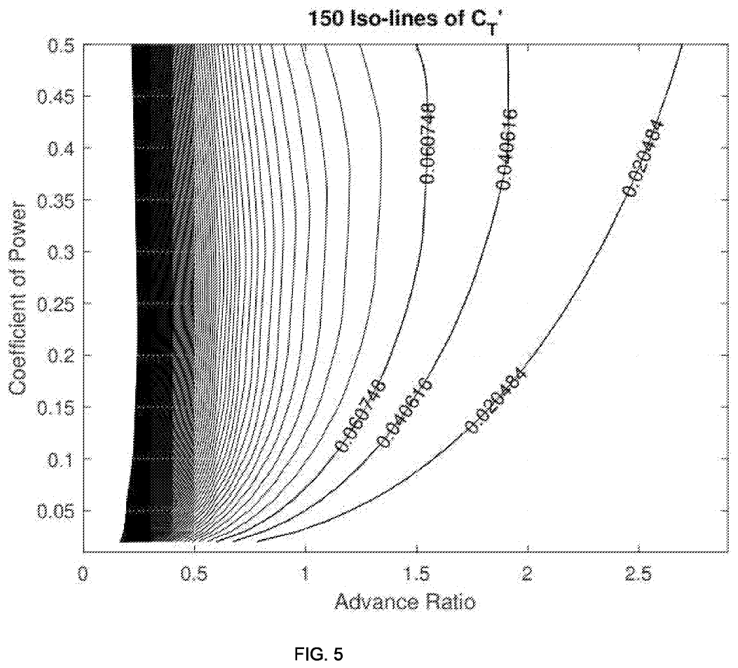

FIG. 5 shows a 3-dimensional graph, relating advance ratio J, coefficient of power Cₚ and propeller pitch angle β to propeller efficiency. Again, as can be seen, propeller efficiency depends strongly on these parameters, with a maximum achievable efficiency given as around 0.8 in this example, but with efficiencies as low as 0.1 also being possible.

In order to calculate the look-up table or online model defining the most efficient propulsion system configuration for given flight conditions, a set-point generation scheme is defined.

Initially, a modified thrust coefficient C′T is defined as:

$${C}_{T}^{′} = {η}_{p} ( J , {C}_{p} ) \frac{{C}_{p} ( J , β )}{J} \qquad Equation 3$$

Where ηₚ(J, Cₚ) is the propeller map from FIG. 4, and Cₚ(J,β) is the propeller map from FIG. 5, but with an inversion of power coefficient and blade angle axes.

This modified thrust coefficient can be related to the airframe's drag coefficient C_{D} as follows:

$${C}_{T}^{′} = \frac{π}{8} {C}_{D} \frac{S}{{S}_{prop}} \qquad Equation 4$$

Where S represents the aircraft wing surface area in square meters, Sₚᵣₒₚ represents the total propeller reference area in square meters (i.e. propeller disc area, the area swept by the propellers and C_{D} represents the coefficient of drag of the aircraft, as conventionally defined.

The drag coefficient at a chosen level flight condition (airspeed and altitude) can be translated to a required modified thrust coefficient. Hence, for a desired true airspeed, the corresponding iso-thrust coefficient line will capture all points on the propeller performance maps that correspond to the chosen flight condition. The following method demonstrates how these iso-lines are used to extract the max overall efficiency points.

For steady-state flight conditions, each iso-line of C′_{T} corresponds to a constant equivalent airspeed. For simplicity, the following considers sea-level conditions, where equivalent and true airspeed are interchangeable. Since equation 3 provides a map of thrust coefficient over J and C_{P}, the iso-lines of C′_{T} can be exposed. Each iso-line of C′_{T} provides all the possible co-ordinates (J,C_{P}) that achieve a given airspeed. It is important to point out that every iso-line will be limited by a physical maximum RPM limit N and minimum RPM N due to stall. This will limit the range of advance ratio J values over which the maximum efficiency search can be performed.

In practice therefore, the set-point generation method includes safety parameters or operational limitations which are excluded from outputs of the optimisation method. Consequently, the set-point generation process includes these limitations, such that set-points that results in exceedance of these limitations are included in the look-up table or model in the controller.

Examples include propeller and motor speed limits. At greater than a particular speed, damage may occur to either the motor or the propeller, and so maximum values are set for these parameters. Similarly, the propeller may stall below a particular propeller rotational speed, relative airflow velocity or relative airflow angle (angle of attack—α), and so limits are set to prevent this. Similarly, depending on the design of the motor 10, the motor may stall at rotational speed below a critical speed, and so a minimum motor speed is also set.

Other limitations may apply to various components. For example, the motor and/or drivetrain (such as shaft 14 and gearbox where present) typically have a maximum permissible torque, beyond which damage may occur. Consequently, limits are set to avoid set-points that exceed these limits. The motor 10, inverter 24 or energy storage unit 18 may have maximum current limitations, which similarly limit the current that can be drawn. Again, these limitations are included in the model.

Once these limitations are included, the parameter space can be searched to find a combination of parameters which provides a required thrust for given flight conditions.

If only the propeller efficiency were to be considered, the search method could comprise merely finding a single coordinate on the propeller efficiency map where both the safety limitations and thrust requirements are met. However, the inventors have found that such a method may result in low overall propulsion system efficiency in view of the significant variation in inverter and motor efficiency at different operating points. This is particularly the case where the motor is not well matched to the load.

However, by using the fact that a modified thrust coefficient iso-line corresponds to a constant equivalent airspeed, all co-ordinates (J, Cₚ) for the iso-line can be translated into equivalent motor speed and torque coordinates; to query the EPU efficiency map, a translation according to equation 5 is performed:

(J,Cₚ)→(Ω(J),τₘ(J,Cₚ)) Equation 5

The translation is performed using equation (1) re-arranged for N, and the following relationship between torque and power coefficient:

$${τ}_{m} = \frac{1}{2 π} ρ {{C}_{p} ( \frac{N}{60} )}^{2} {d}^{5} \qquad Equation 6$$

This gives a relationship between advance ratio J and coefficient of power Cₚ, and modified coefficient of thrust C′ₜ.

Now, for a given airspeed, the motor efficiency map can be queried along an iso-line knowing the translation (13). Therefore, for each iso-line, the product of propeller and motor efficiency can be found. The maximum overall efficiency is denoted η*₀, where the superscript * denotes variables at maximum overall efficiency. The maximum overall efficiency η*₀ is defined as:

η*₀=ηₘ(Ω*,τ*ₘ)ηₚ(J*,C*ₚ) Equation 7

Where ηₘ(Ω*,τ*ₘ) is the motor efficiency as a function of motor speed Ω and motor torque τₘ, and ηₚ is the propeller efficiency as a function of advance ratio J and the power coefficient Cₚ. Once these optimum values are selected, a look-up table on the basis of either parameter pair can then be constructed. Once optimal values for (J,Cp) are found, the pitch angle can be found from querying prop data that relates J,Cp and beta. Such data is typically provided by manufacturers, or can be determined from experimentation.

In some cases, multiple solutions may exist, i.e. there may exist multiple values of motor speed motor speed Ω, motor torque τₘ, advance ratio J and the power coefficient Cₚ which provide equally high efficiency. In such a case, a suitable coordinate can be chosen using an additional constraint such as a smallest motor or propeller rotational speed or P_{shaft}. Alternatively, a value which is closest to the current value may be selected, to avoid “hunting” behaviour by the propulsion system.

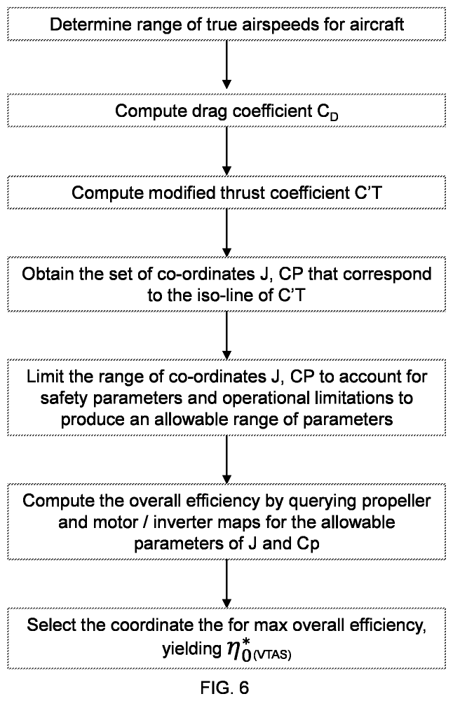

Consequently, a method can be defined for calculating the look-up table or online model, which relates current airspeed and desired thrust to corresponding motor and propulsor configurations which generate a maximum propulsion system efficiency. Such a method is illustrated in the flow diagram in FIG. 6, and comprises the following steps:
1. Generate a range of steady-state equivalent true airspeeds over which the airframe is to fly at. This can be derived from a consideration of aircraft performance (speed and altitude) capability, which may in turn be determined from parameters such as thrust and drag, as well as likely atmospheric conditions such as temperatures.
2. For each airspeed:
   a. Compute the drag coefficient C_{D} of the aircraft;
   b. Compute the modified thrust coefficient C′_{T} (from equation 4);
   c. Obtain the set of co-ordinates J, C_{P} that correspond to the iso-line of C′_{T}, using the map generated from equation 3;
   d. Limit the range of co-ordinates J, C_{P} to account for safety parameters and operational limitations to produce an allowable range of parameters;
   e. Compute the overall efficiency by querying propeller and motor/inverter maps for the allowable parameters of J and Cₚ; and
   f. Select the coordinate (i.e. motor and propulsor parameters) the for max overall efficiency, yielding η*_{0(VTAS)}.

Consequently, knowing (J*, C*ₚ) for a chosen V_{TAS} gives all of the information to compute the optimal settings for motor torque and constant speed governor set-point, or motor speed and propeller blade angle.

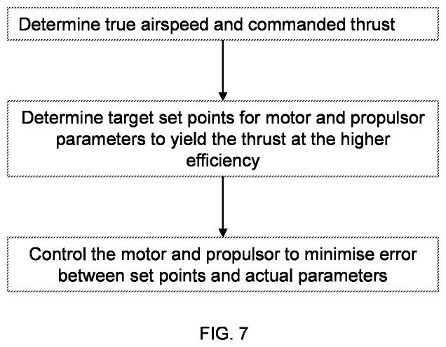

Similarly, FIG. 7 shows a flow chart illustrating the steps required for control of the aircraft propulsion system in accordance with the above computed parameters:
1. Determine the true airspeed and commanded thrust, through communication with aircraft air data sensors and pilot or autopilot input;
2. Determine target set points for motor and propulsor parameters to yield the thrust at the highest possible propulsion system efficiency, utilising the lookup table generated in accordance with the method shown in FIG. 6; and
3. Control the propulsion system to minimise error between the set-points and the actual parameters.

By operating the aircraft to this maximum efficient configuration, the aircraft performance is significantly improved. The inventors have found that efficiency improvements of around 2% can be realised by operating the propulsion system in accordance with the above method. Such an improvement is significant in the field of electric aircraft, in view of the large weight and low energy density of electric energy storage systems. For example, a 2% reduction in energy usage may correspond to a greater than 2% increase in range, in view of the logarithmic relationship between aircraft energy storage capacity and resultant range.

Variations of the above described arrangement can be envisaged. For example, the control scheme can be applied to hybrid aircraft, as well as purely electric aircraft.

Parallel and series hybrid aircraft have been proposed, in which one or more internal combustion engine is combined with one or more electric motors to drive one or more propulsors. Parallel hybrid systems can be distinguished from so-called “series hybrid” systems. In a parallel hybrid system, a mechanical connection is provided by the internal combustion engine and at least one propulsor, with at least one electric motor driving either the same propulsor as that driven by the internal combustion engine, or a further propulsor. In a series system, no mechanical link is provided between the internal combustion system and the propulsors.

In such a case, an efficiency map of the gas turbine engine or other internal combustion engine could be considered when determining the maximally efficient operating configuration.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of controlling an electric propulsion system of an aircraft, the propulsion system comprising an electric motor configured to drive a variable pitch propulsor, the method comprising:
determining a commanded thrust setting;
determining one or more flight parameters;
determining either a corresponding rotor governor speed and motor torque set-point, or a corresponding motor speed and rotor pitch angle set point, which provides the commanded thrust setting at the determined flight parameter having a maximum propulsion system efficiency; and
controlling the rotor governor and electric motor in accordance with the determined respective set-points.

2. A method according to claim 1, wherein the method comprises consulting a lookup table which stores either a corresponding governor speed and motor torque set-point or a corresponding motor speed and rotor pitch angle set point for the determined one or more flight parameters.

3. A method according to claim 1, wherein the method comprises inputting aircraft characteristics and flight parameters to an aircraft propulsion system model, and outputting one of the corresponding rotor governor speed and motor torque set-point, and the corresponding motor speed and rotor pitch angle set point.

4. A method according to claim 3, wherein the aircraft propulsion system model comprised one or more of an aircraft drag model, a propeller efficiency model, a motor efficiency model, and a power source efficiency model.

5. A method according to claim 1, wherein the one or more aircraft flight parameters includes one or more of an aircraft true airspeed and aircraft equivalent airspeed.

6. A method according to claim 1, wherein the method comprises determining a maximum propulsion system efficiency by calculating a minimum motor input power corresponding to the required thrust.

7. A method according to claim 1, wherein the method comprises determining one or more safety parameters or operational limitations, and outputting rotor governor speed and motor torque set-point which meets these safety parameters or limitations.

8. A method according to claim 7, wherein the method comprises determining one or more of a maximum rotor speed, motor torque, maximum rotor input current and maximum energy storage system output current and maintaining the corresponding rotor governor speed and motor torque set-point below their respective maxima.

9. A method according to claim 1, wherein the method comprises determining one or more energy storage system efficiency parameters, and determining a corresponding rotor governor speed and motor torque set-point which provides the commanded thrust setting at the determined flight parameter with a maximum propulsion system efficiency.

10. A method according to claim 1, wherein the method comprises determining one or more power electronics efficiency parameters, and determining a corresponding rotor governor speed and motor torque set-point which provides the commanded thrust setting at the determined flight parameter with a maximum propulsion system efficiency.

11. A control system for an aircraft electric propulsion system, the aircraft propulsion system comprising:
a variable pitch propulsor;
an electric motor coupled to the variable pitch propulsor; and
a controller configured to control the variable pitch propulsor and electric motor in accordance with the method of claim 1.

12. An aircraft propulsion system comprising a control system in accordance with claim 11.

13. An aircraft propulsion system according to claim 12, wherein the aircraft propulsion system comprises one or more energy storage units.

14. An aircraft propulsion system according to claim 12, wherein the aircraft propulsion system comprises one or more internal combustion engines such as one or more gas turbine engines.

15. An aircraft comprising a propulsion system in accordance with claim 11.
